(19) United States
(12) Patent Application Publication
(10) Pub. No.: US 2006/0278292 A1
(43) Pub. Date: Dec. 14, 2006

(54) Extrusion blow-molded filling tube made of plastic

(76) Inventors: Thomas Froitzheim, Augustin (DE); Frank Hager, St. Augustin (DE); Matthias Borchert, Bonn (DE); Marco Engels, Bonn (DE); Georg Reinelt, Bonn (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/560,630

(22) PCT Filed: May 25, 2004
(86) PCT No.: PCT/DE04/01082

§ 371 Date: May 30, 2006

(30) Foreign Application Priority Data
Jun. 11, 2003 (DE) 103 26 642.9

(51) Int. Cl. F16L 11/00

(52) U.S. Cl. 138/137; 138/121; 138/109

(57) ABSTRACT

The invention relates to an extrusion blow-molded filling tube (1) made of plastic for a motor vehicle fuel tank, which consists of a multilayered coextrudate and has mouth areas (7) at each end, which each have a flange and/or faces (8) provided for welding to connecting parts. The inventive filling tube (1) is characterized in that the two mouth areas (7), which are located at different ends, are provided with a defined wall thickness and a defined inside diameter.

The invention relates to an extrusion blow-molded pipe of plastic material, in particular a filling pipe for a motor vehicle fuel tank, which comprises a multi-layer coextrudate and which has respective mouth regions at each end, which each have flanges and/or end faces provided for welding to connecting components.

Such filling pipes are usually calibrated at one end. The term calibrating is used to denote the production of a defined wall thickness and a defined inside diameter for the component to be produced. Hollow bodies which were produced by blow molding are known not to have a defined wall thickness, due to the manufacturing procedure involved. The tubular preform which is taken from the extruder is expanded by means of blowing air within a multi-part blowing mold whose mold cavity or molding space determines the external contour of the finished component. It will be appreciated that, in the case of a filling pipe produced in that way, only a defined external contour can be produced. The wall thickness of the hollow body produced in that way is not the same everywhere because of different stretching of the material which is expanded in the mold. If pipes or other components which have to be welded to other components are to be produced, it is necessary to provide a defined wall thickness and a defined contact surface or welding surface, in the region of the faces which are provided for the welding operation. That is particularly important, especially in the production of filling pipes of motor vehicle fuel tanks. Those extrusion blow-molded pipes which are made from plastic material are welded to a fuel tank of plastic material which is also produced by extrusion blowing, in the region of a filling opening of the fuel tank. The weld join is subjected to forces inter alia upon fitting of the fuel tank. A certain minimum load-bearing capability on the part of the weld join is therefore essential, not least also for reasons of sealing integrity.

Known filling pipes are frequently in the form of so-called 3D-parts (curved in a plurality of planes in space) and are of a multi-layer configuration. They are usually welded on the one hand to a fuel tank of plastic material and on the other hand to another connecting component, for example an electrically conducting collar or the like. In that case a suitably adapted configuration for the filling pipe is desirable at both ends or, in the case of a pipe which has multiple branchings, at a plurality of locations.

Known filling pipes have hitherto been produced in the form of filling pipes which are calibrated at one end. The end in opposite relationship to the calibrated end of the pipe was hitherto blown in the form of a so-called ‘dead head’. This involves a dome-shaped cup which is provided at one end of the blown portion and which, after the blow molding is finished, is subjected to a post-working procedure, for example is cut out in a circle or cut off. In order to produce at that end of the filling pipe a separation surface which is suitable for welding, hitherto for example the procedure adopted was such that the closed end of the preform, which was to be subjected to the post-processing operation, was subjected to upsetting from the outside after closure of the blow molding mold by means of a ram to form a defined separation surface. In the region of the separation surface produced by the upsetting operation the dead head of the preform was cut off in a post-working step.

In that way the production of a peripherally extending separation surface or a peripherally extending flange caused folding of the material in the mouth region of the pipe so that, if the pipe were produced in the form of a multi-layer pipe, the positions of the layers of the coextrudate in that region no longer corresponded to the desired reference position.

That is a particular problem if the coextrudate includes barrier layers for hydrocarbons of EVOH (ethylene vinyl alcohol) which for example cannot be welded to PE (polyethylene).

The object of the invention is therefore that of so improving an extrusion blow-molded filling pipe of plastic material of the kind set forth in the opening part of this specification that the weldability of the mouth regions and the load-bearing capability of the weld to be produced are improved.

The object of the invention is attained in that at least two mouth regions of the filling pipe, which are at different ends, are calibrated. In other words, two mutually oppositely disposed mouth regions of the filling pipe are each of a defined inside diameter and a defined wall thickness respectively so that the respective mouth regions are equally suitable for welding to or on connecting components. The term connecting component in accordance with the invention can here be used to denote both the outside skin of the motor vehicle fuel tank and for example an electrically conducting collar on the filling pipe.

The term filling pipe in accordance with the invention can also be used to denote a complex multi-pipe component having more than two openings, as is frequently the case with air ducts, cooling water conduits, filling pipes or the like for motor vehicles.

Calibration at both sides or both ends of extrusion blow-molded hollow bodies is in particular hitherto not known in the case of so-called 3D parts, that is to say in the case of pipes which are curved in at least two planes. The filling pipe according to the invention can be for example in the form of a complex 3D part which is curved in two or more planes. Desirably this involves a seamlessly produced, core-free pipe.

It is particularly advantageous if the inner layer of the coextrudate, in relation to the cross-section of the filling pipe, at least predominantly forms the end face of the respective mouth region, the end face being provided for the welding operation. In the case of the described multi-layer structure of the preform, that has the advantage that particularly good weldability of the filling pipe is afforded if the inner layer of the filling pipe comprises a plastic material which is compatible for welding to the attachment component or connecting component. Frequently for example the situation is such that the outside skin of plastic material fuel tanks comprises polyethylene, in that case it is appropriate if the inner layer of the filling pipe also comprises polyethylene.

In a particularly advantageous configuration of the extrusion blow-molded filling pipe according to the invention it is provided that it includes a barrier layer in relation to hydrocarbons, comprising a plastic material which is impermeable or difficultly permeable in relation to hydrocarbons.

The barrier layer can comprise for example EVOH (ethylene vinyl alcohol).

Preferably the barrier layer is completely embedded in polyethylene layers.

The filling pipe can comprise for example a five-layer or six-layer coextrudate, in which case at least one layer comprises a recycled material in known manner.

The invention is described hereinafter by means of an embodiment by way of example illustrated in the drawings in which:

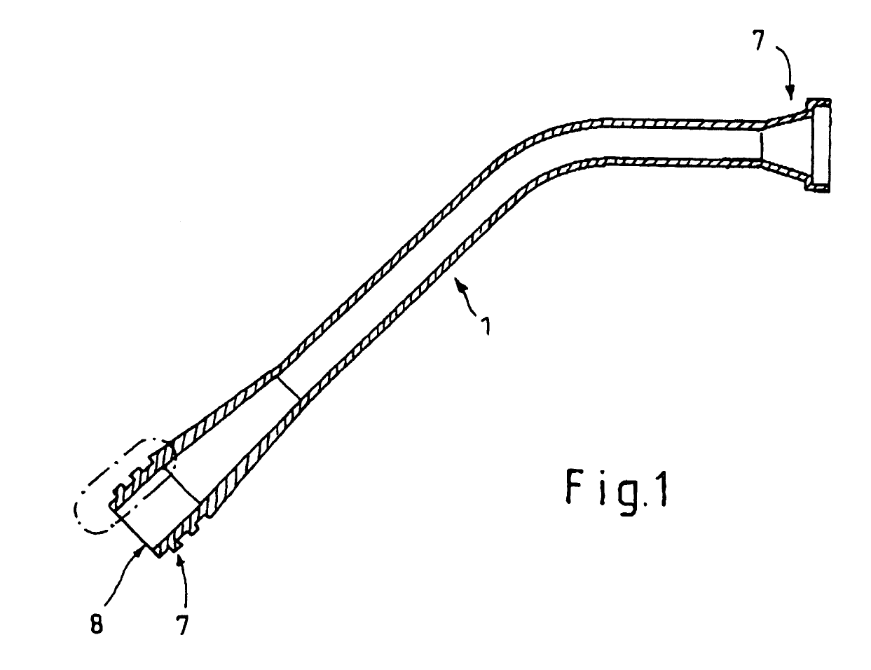

FIG. 1 is a view in longitudinal section through a filling pipe of the invention, and

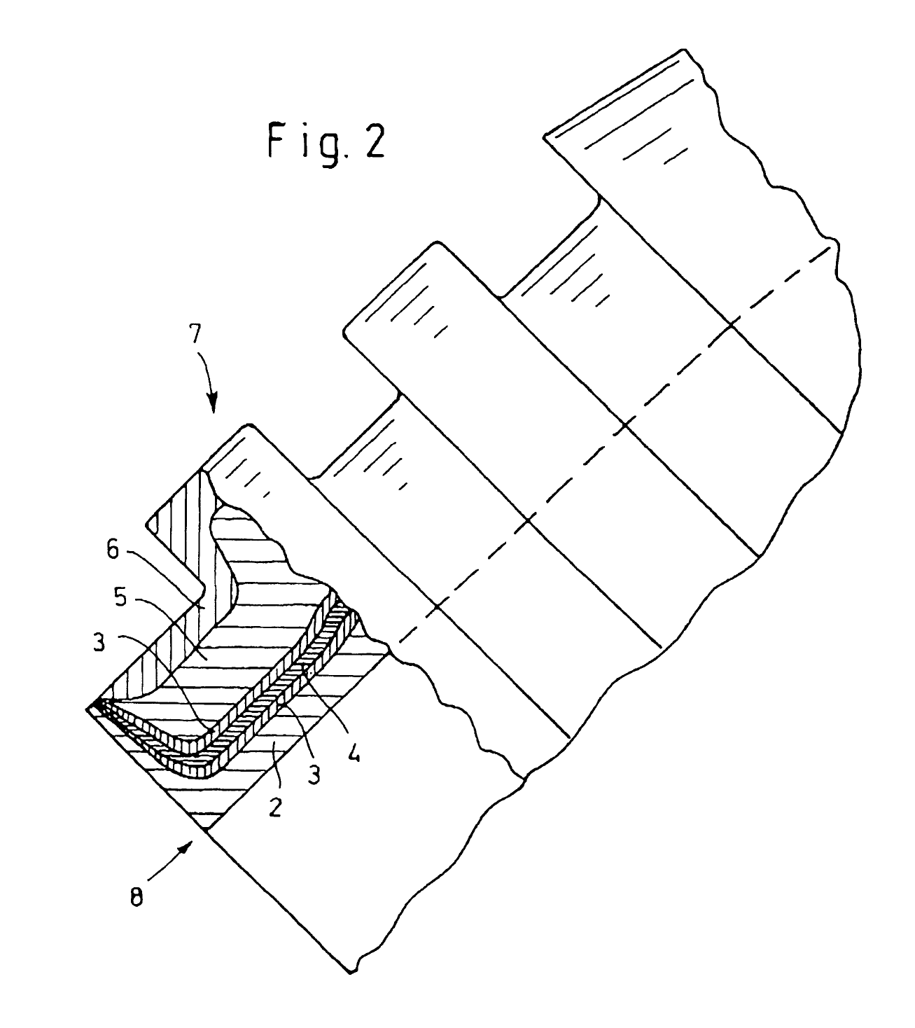

FIG. 2 is a partial section on an enlarged scale through the mouth region of the filling pipe which is shown in FIG. 1, illustrating the layer configuration in the wall of the filling pipe.

The filling pipe 1 in accordance with the illustrated embodiment is in the form of a pipe which is coextruded in six-layer form and which was obtained by extrusion blow molding. This involves a filling pipe 1 which was produced seamlessly, that is to say in a core-free procedure. Such low-waste production processes for the production of components which involve multiple spatial curvature, that is to say which are curved in a plurality of planes in space, have long been known and are not intended to be subject-matter of the invention. The layer structure of the filling pipe 1 includes from the inside outwardly an inner layer 2 as a pure polyethylene layer, a bonding layer 3, a barrier layer 4 of EVOH, a further bonding layer 3, an intermediate layer 5 as a regenerated material layer and an outer layer 6 in the form of a colored polyethylene layer.

As is readily apparent from FIG. 1 the filling pipe 1 includes two mouth regions 7 which are each expanded outwardly. The two mouth regions 7 are of a defined wall thickness and a defined inside diameter.

It will be seen from FIG. 2 that the end faces 8 of the filling pipe 1 in the mouth regions 7 are formed at least predominantly by the inner layer 2 of pure polyethylene. In addition the filling pipe 1 which is calibrated in both mouth regions 7 is, at each of those locations, of a wall thickness which remains the same over the entire periphery thereof so that the end faces 8 have optimum properties in terms of welding to another plastic material component. The configuration of the layers of the coextrudate in the mouth region 7 of the filling pipe 1, as shown in FIG. 2, was achieved by the insertion of a particular calibration bar into each of the ends of the filling pipe 1 in the production thereof.

### List of references

1 filling pipe
2 inner layer
3 bonding layer
4 barrier layer of EVOH
5 intermediate layer
6 outer layer
7 mouth regions
8 end faces

1. An extrusion blow-molded pipe of plastic material, in particular a filling pipe for a motor vehicle fuel tank, which comprises a multi-layer coextrudate and which has respective mouth regions at each end, which each have flanges and/or end faces provided for welding to connecting components, characterised in that at least two mouth regions at different ends are calibrated.

2. An extrusion blow-molded filling pipe as set forth in claim 1 characterised in that it is curved in at least two planes.

3. An extrusion blow-molded filling pipe as set forth in claim 1 characterised in that it is formed seamlessly (core-free).

4. An extrusion blow-molded filling pipe as set forth in claim 1 characterised in that the inner layer of the coextrudate, with respect to the cross-section of the filling pipe, at least predominantly forms the end face, which is provided for the welding operation, of the respective mouth region.

5. An extrusion blow-molded filling pipe as set forth in claim 1 characterised in that it includes a barrier layer against hydrocarbons, which comprises a plastic material which is impermeable or difficultly permeable for hydrocarbons.

6. An extrusion blow-molded filling pipe as set forth in claim 5 characterised in that the barrier layer comprises EVOH (ethylene vinyl alcohol).

7. An extrusion blow-molded filling pipe as set forth in claim 4 characterised in that the barrier layer is embedded completely in polyethylene layers.

8. An extrusion blow-molded filling pipe as set forth in claim 1 characterised in that it comprises a five-layer or six-layer coextrudate.
